(19) United States
(12) Patent Application Publication
(10) Pub. No.: US 2013/0239043 A1
(43) Pub. Date: Sep. 12, 2013

(54) COMPUTING DEVICE AND METHOD FOR MANAGING DISPLAY OF WIDGET

(71) Applicants: Zhong-Lin XU, Shenzhen City (CN); Yao-Hua LIU, Shenzhen City (CN); Rong-Rong PENG, Shenzhen City (CN); Qing-Ling ZHANG, Shenzhen City (CN); Zhi-Feng WANG, Shenzhen City (CN); Xi LIN, Shenzhen (CN); Yun-Yan WU, Shenzhen City (CN); Xin LU, Shenzhen City (CN); Shih-Fang WONG, Tu-Cheng (TW)

(72) Inventors: Zhong-Lin XU, Shenzhen City (CN); Yao-Hua LIU, Shenzhen City (CN); Rong-Rong PENG, Shenzhen City (CN); Qing-Ling ZHANG, Shenzhen City (CN); Zhi-Feng WANG, Shenzhen City (CN); Xi LIN, Shenzhen (CN); Yun-Yan WU, Shenzhen City (CN); Xin LU, Shenzhen City (CN); Shih-Fang WONG, Tu-Cheng (TW)

(73) Assignees: HON HAI PRECISION INDUSTRY CO., LTD., Tu-Cheng (TW); Fu Tai Hua Industry (Shenzhen) Co., Ltd., ShenZhen City (CN)

(21) Appl. No.: 13/437,049

(22) Filed: Apr. 2, 2012

(30) Foreign Application Priority Data
Mar. 7, 2012 (CN) 201210057632.2

(51) Int. Cl. G06F 3/048

(52) U.S. Cl. 715/780

(57) ABSTRACT

A method for managing display of a widget, the widget is displayed in a form of a predetermined textbox on a user interface before the widget has got focus. When the widget has got focus, corresponding functions of the widget are executed, and preset original data of the widget is displayed through the widget. When the widget has lost focus, the display of the widget is reverted to the predetermined textbox, and inputted or selected information by the user through the widget is displayed in the predetermined textbox.

### BACKGROUND

1. Technical Field

Embodiments of the present disclosure relate to a computing device and a method for managing display of a widget.

2. Description of Related Art

In computer programming, widgets (or controls) are computer programs that when executed displays in a graphical user interface (GUI) environment. A particular GUI, such as a user interface of a webpage, may include a number of widgets (e.g., text input boxes, list boxes, and check boxes) that are configured for interacting with the user. The widgets, may occupy most of the real estate of the GUI, and the GUI may be disorganized if a great many of the widgets are displayed thereon, this is inconvenient. Therefore, there is room for improvement in the art.

### BRIEF DESCRIPTION OF THE DRAWINGS

FIG. 1 is a schematic block diagram illustrating one embodiment of a computing device including a management system.

FIG. 2 illustrates examples of different types of widgets.

FIG. 3 to FIG. 5 illustrates one embodiment of managing the display of a widget according to a particular widget type.

FIG. 6 is a flowchart of one embodiment of a method for managing the display of the widget that is implemented by the computing device of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

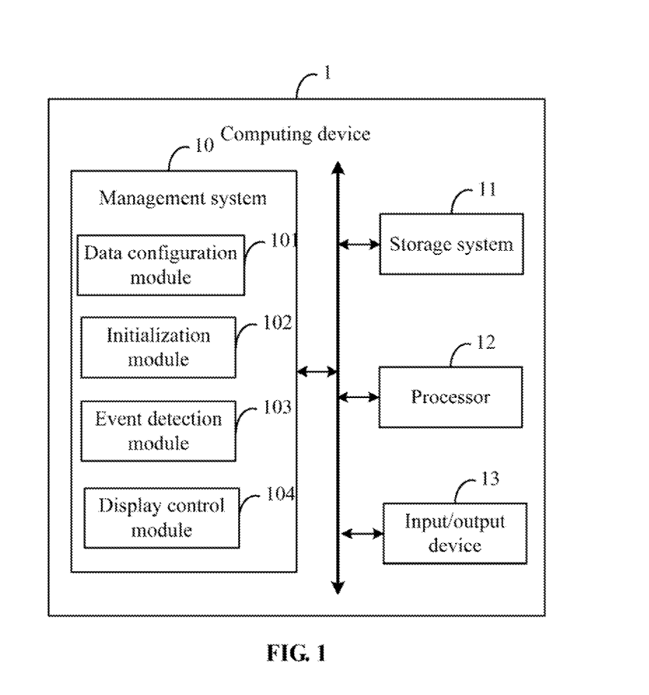

FIG. 1 illustrates one embodiment of a computing device 1 including a management system 10. In the embodiment, the computing device 1 further includes a storage system 11, a processor 12, and an input/output device 13. In one embodiment, the computing device 1 may be, for example, a desktop computer, a notebook computer, or other similar devices. The input/output device may include a mouse and a keyboard, for example. FIG. 1 is only one example of the computing device 1, and the computing device 1 can include more or fewer components than those shown in the embodiment, or have a different configuration of the components.

The management system 10 may include a plurality of programs in the form of one or more computerized instructions stored in the storage system 11 and executed by the processor 12 to perform operations of the computing device 1. In the embodiment, the management system 10 includes a data configuration module 101, an initialization module 102, an event detection module 103, and a display control module 104. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

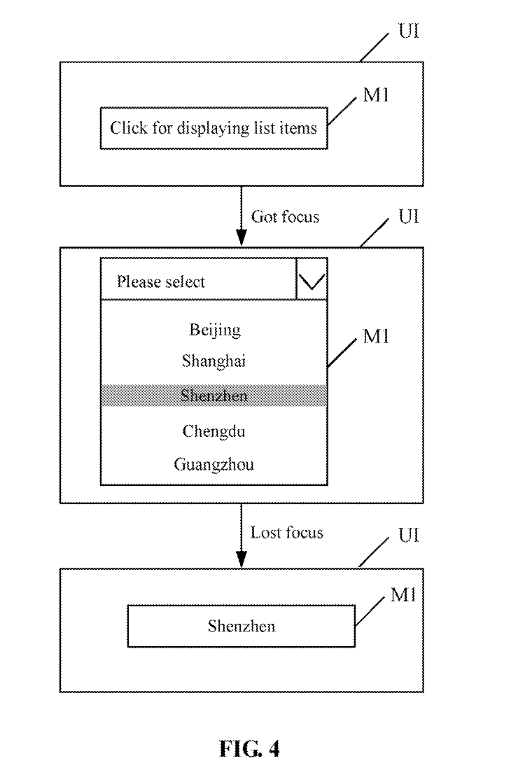

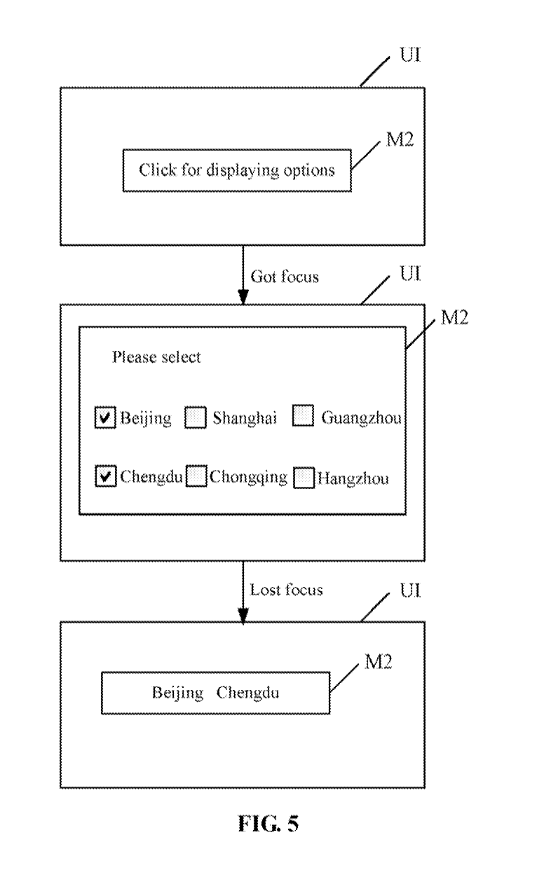

The data configuration module 101 sets original data of a widget, the original data including a widget type, and information to be displayed and selected by a user through the widget when the user interacts with the widget. In the embodiment, the widget type may be, for example, a text entry box, a list box, or a check box. The text entry box is a type of widget that allows the user to input text information to be used by a program of the widget. The list box is a type of widget that allows the user to select one or more items from a list contained within a static, multiple line text box. The user may click an item inside the list box to select it, and sometimes in combination with a Shift key or a Control key of the keyboard of the input/output device 1 in order to make multiple selections. The check box is a type of widget that permits the user to make single or multiple selections from a number of options. Normally, the check box is shown on a user interface as a square box that contains the options. In one example, if the widget is the list box or the check box, the original data may include a plurality of items or options that the user can select wherefrom, such as “Beijing”, “Shanghai”, and “Shenzhen” of FIG. 4 or FIG. 5. If the widget is the text entry box, the set information of the original data to be selected by the user may be set as null.

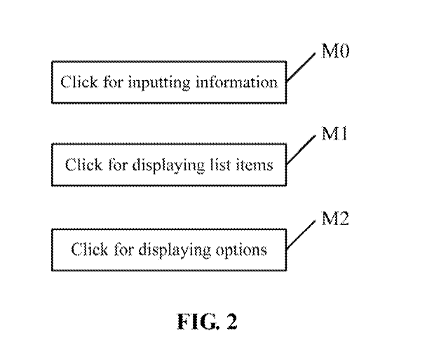

The initialization module 102 displays the widget in a form of a predetermined textbox on a user interface (UI), and displays predetermined initial information in the textbox according to the widget type. In one example, as shown in FIG. 2, if the widget type is a text entry box MO, the initial information displayed in the textbox may be “Click for inputting information”. If the widget type is a list box M1, the initial information displayed in the textbox may be “Click for displaying list items”.

If the widget type is a check box M2, the initial information displayed in the textbox may be “Click for displaying options”.

The event detection module 103 detects focus events of the widget, the focus events including a got focus event and a lost focus event. In one embodiment, when the widget is selected, such as clicked using the mouse or the keyboard of the input/output device 1, the got focus event of the widget is detected, which means the widget has got focus. In contrast, the lost focus event of the widget may be detected when the widget is unselected (e.g., another element on the UI is clicked) after the widget has been selected, which means the widget has lost focus.

The display control module 104 executes corresponding functions of the widget according to the widget type and displays the set information of the original data on the UI through the widget, when the got focus event of the widget is detected. The display control module 104 further reverts the display of the widget to the textbox, and displays information that is inputted or selected by the user through the widget in the textbox, when the lost focus event of the widget is detected.

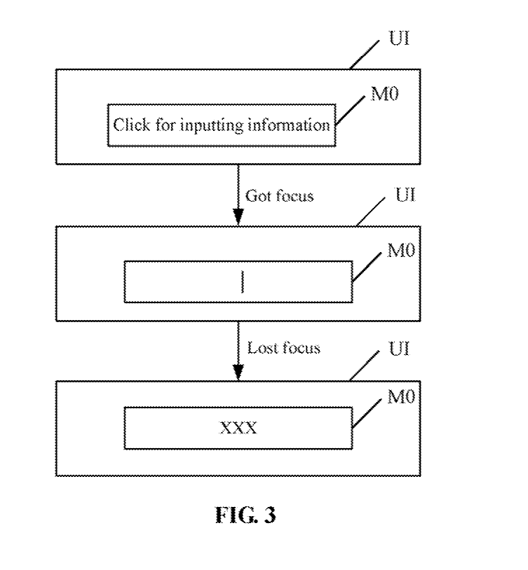

Referring to FIG. 3, if the widget is the text entry box MO, the text entry box MO is displayed as a blank text entry box for receiving any text information input therefrom by the user, when the widget has got the focus. When the text entry box MO has lost focus, the display of the text entry box MO reverts to the predetermined textbox, and text messages “XXX” inputted by the user are displayed in the predetermined textbox.

Referring to FIG. 4, if the widget is the list box M1, the list box M1 is displayed as a dropdown menu that includes the set items to be selected by the user, when the got focus event of the widget is detected. When the list box M1 loses focus, the display of the list box M1 is reverted to the predetermined textbox, and an item “Shenzhen” selected by the user is displayed in the textbox. It is understood that, if no option has been selected, no information is displayed in the textbox, and the reverted textbox may be a blank textbox.

Referring to FIG. 5, if the widget is the check box M2, when the widget gets the focus, the check box M2 is displayed as a square box that includes the set options, from which the user can select one or more required options. When the check box M2 loses the focus, the display of the check box M2 is reverted to the predetermined textbox, and options “Beijing” and “Chengdu” selected by the user are displayed in the predetermined textbox.

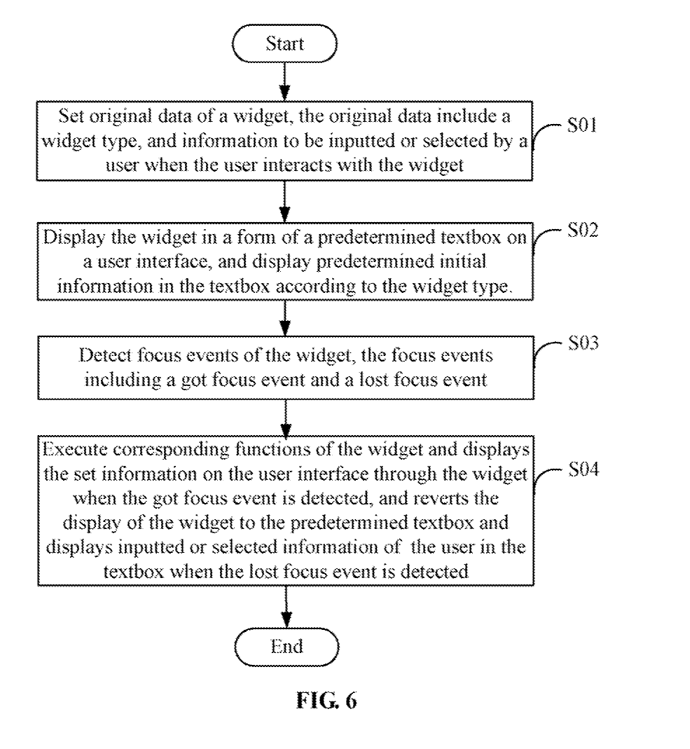

FIG. 6 is a flowchart of one embodiment of a method for managing display of the widget that is implemented by the computing device 1 of FIG. 1. Depending on the embodiment, additional steps may be added, others removed, and the ordering of the steps may be changed.

In step S01, the data configuration module 101 sets original data of the widget, the original data include a widget type, and information to be displayed through the widget for being selected by a user when the user interacts with the widget. In the embodiment, the widget type may be, for example, a text entry box, a list box, or a check box. Details of the text entry box, the list box, and the check box are described above.

In step S02, the initialization module 102 displays the widget in a form of a predetermined textbox on the user interface, and displays predetermined initial information in the predetermined textbox according to the widget type.

In step S03, the event detection module 103 detects focus events of the widget, the focus events including a got focus event and a lost focus event. Details of the got focus event and the lost focus event are provided above.

In step S04, the display control module 104 executes corresponding functions of the widget according to the widget type and displays the set information of the original data on the user interface through the widget when the got focus event of the widget is detected, and reverts the display of the widget to the predetermined textbox and displays information that is inputted or selected by the user through the widget in the predetermined textbox when the lost focus event of the widget is detected.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A method for managing display of a widget using a computing device, the method comprising:
setting original data of the widget, the original data comprising a widget type, and information to be displayed through the widget for being selected by a user when the user interacts with the widget;
displaying the widget in a form of a predetermined textbox on a user interface, and displaying predetermined initial information in the predetermined textbox according to the widget type;
detecting focus events of the widget, the focus events comprising a got focus event and a lost focus event; and
executing corresponding functions of the widget according the widget type and displaying the set information of the original data on the user interface through the widget when the got focus event of the widget is detected, and reverting the display of the widget to the predetermined textbox and displaying information that is inputted or selected by the user through the widget in the predetermined textbox when the lost focus event of the widget is detected.

2. The method according to claim 1, wherein the widget type is a text entry box, a list box, or a check box.

3. The method according to claim 2, wherein the information to be displayed through the widget is set as null if the widget type is the text entry box, and the executing step comprises:
displaying the text entry box as a blank text entry box for receiving text information input from the user when the got focus event of the widget is detected, and reverting the display of the text entry box to the predetermined textbox and displaying text information that is inputted by the user through the text entry box in the predetermined textbox when the lost focus event of the widget is detected.

4. The method according to claim 2, wherein the information to be displayed through the widget comprises a plurality of items if the widget type is the list box, and the executing step comprises:
displaying the list box as a dropdown menu that comprises the items to be selected by the user when the got focus event of the widget is detected, and reverting the display of the list box to the predetermined textbox and displaying one or more of the items that are selected by the user in the predetermined textbox when the lost focus event of the widget is detected.

5. The method according to claim 1, wherein the information to be displayed through the widget comprises a plurality options for being selected by the user if the widget type is the check box, and the executing step comprises:
displaying the check box as a square box that comprises the options when the got focus event of the widget is detected, and reverting the display of the check box to the predetermined textbox and displaying one or more of the options that are selected by the user in the predetermined textbox when the lost focus event of the widget is detected.

6. A computing device, comprising:
a storage system;
at least one processor;
one or more programs stored in the storage system and executed by the at least one processor, the one or more programs comprising:
a data configuration module that sets original data of a widget, the original data comprising a widget type, and information to be displayed through the widget for being selected by a user when the user interacts with the widget;
an initialization module that displays the widget in a form of a predetermined textbox on a user interface, and displays predetermined initial information in the predetermined textbox according to the widget type;
an event detection module that detects focus events of the widget, the focus events comprising a got focus event and a lost focus event; and
a display control module that executes corresponding functions of the widget according to the widget type and displays the set information of the original data on the user interface through the widget when the got focus event of the widget is detected, and reverts the display of the widget to the predetermined textbox and displays information that is inputted or selected by the user through the widget in the predetermined textbox when the lost focus event of the widget is detected.

7. The computing device according to claim 6, wherein the widget type is a text entry box, a list box, or a check box.

8. The computing device according to claim 7, wherein the information to be displayed through the widget is set as null if the widget type is the text entry box, and the display control module displays the text entry box as a blank text entry box for receiving text information input from the user when the got focus event of the widget is detected, and reverts the display of the text entry box to the predetermined textbox and displays text information inputted by the user through the text entry box in the predetermined textbox when the lost focus event of the widget is detected.

9. The computing device according to claim 7, wherein the information to be displayed through the widget comprises a plurality of items if the widget type is the list box, and the display control module displays the list box as a dropdown menu that comprises the items to be selected by the user when the got focus event of the widget is detected, and reverts the display of the list box to the predetermined textbox and displays one or more of the items that are selected by the user in the predetermined textbox when the lost focus event of the widget is detected.

10. The computing device according to claim 7, wherein the information to be displayed through the widget comprises a plurality of options for being selected by the user if the widget type is the check box, and the display control module displays the check box as a square box that comprises the options when the got focus event of the widget is detected, and reverts the display of the check box to the predetermined textbox and displays one or more of the options that are selected by the user in the predetermined textbox when the lost focus event of the widget is detected.
